(19) United States
(12) Patent Application Publication
(10) Pub. No.: US 2013/0043180 A1
(43) Pub. Date: Feb. 21, 2013

(54) Filtration Device

(71) Applicants: Heiko Freter, Einbeck (DE); Wolfgang Russe, Schonwalde-Glien (DE); Stephan Fritsch, Paderborn (DE)

(72) Inventors: Heiko Freter, Einbeck (DE); Wolfgang Russe, Schonwalde-Glien (DE); Stephan Fritsch, Paderborn (DE)

(73) Assignee: A. KAYSER AUTOMOTIVE SYSTEMS GMBH, Einbeck (DE)

(21) Appl. No.: 13/695,124

(22) PCT Filed: Mar. 31, 2011
(86) PCT No.: PCT/EP2011/001625

§ 371 Date: Oct. 29, 2012

(30) Foreign Application Priority Data
May 7, 2010 (DE) 102010019873.0

(51) Int. Cl. B01D 33/48

(52) U.S. Cl. 210/330

(57) ABSTRACT

A filtration device designed for the purpose of recovering filtrate from wastewaters is characterized by a rotor system (2) that is drivable in rotary manner about a horizontal axis (5) in a liquid bath in a receptacle (1), and which serves as the support for multiple assemblies (17) of filter discs, the interior spaces of which are connected to the suction side of a pump (39) via a collection chamber (29). The liquid to be filtered is transported with the aid of a pump (40) that is connected to a plurality of distributor lances (35) that extend parallel to and close to the hollow shaft (21) that supports the rotor system (2) via a line (31) with the interposition of a prefilter (41) that is intended to separate a coarse fraction. The central introduction of the prefiltered liquid distributed evenly over the length of the rotor system (2) via the distributor lances (35) in conjunction with a network (36) of lines designed to introduce air bubbles into the liquid bath and located in the bottom of the receptacle (1) results in a stable operation that also suppresses the formation of deposits and engenders high and consistent filter efficiency.

The invention relates to a filtration device as described in the preamble of claim 1.

Filtration devices of such kind are used to clean liquids that carry an insoluble pollution load, particularly wastewater, with the objective of recovering a reusable filtrate. However, they may also be used generally to separate a solid-liquid mixture to into a solid phase and a liquid phase.

These devices are known in the form of rotating suction filters, for example, in which a rotor system is disposed rotatably about a horizontal axis in a liquid bath, and serves as the support for disc-shaped filter elements the inner sides of which are loaded with a negative pressure. The problem with this arrangement is that the filtration efficiency, measured according to the detected filtrate output, depends on the layer thickness of the solid deposits that form and grow progressively over time on the filter surfaces of the filter elements, but also inevitably inside the liquid bath. In order to achieve stable stationary operation of the device, it is therefore essential to implement measures intended to remove these accumulations or at least to slow the rate at which they grow.

A filtration device in which a rotor system is disposed so as to be rotatable about a horizontal axis in a liquid bath and is in driven connection with an electric motor so that it may be driven about this axis is known from document DE 10 2004 063 879 A1. The rotor system comprises a hub, on which multiple assemblies of disc-shaped filter elements are supported and retained in a staggered side-by-side formation, each of which encloses a cavity, and wherein the cavities of each of the multiple assemblies are combined via collector lines that are connected radially outwardly, and the collector lines of all these assemblies are merged centrally and are in connection with a vacuum pump. The assemblies enclose a chamber that extends coaxially with the axis of the hub, and into which a lance protrudes for the purpose of introducing scavenging air. Another lance, also for introducing scavenging air, that may be activated if the need arises, is located in the floor underneath the rotor system. A pressurised cleaning liquid may be directed at the filter elements via another pump, which is connected to the line branch that contains the vacuum pump.

Because of the multiplicity of means used for purification purposes, that is to say for preventing, slowing the formation of and eliminating accumulated deposits, the structural design of this filtration device is relatively complicated, since it still requires two scavenging air lances, which can be activated alternatively as needed, and an additional pump intended exclusively for feeding cleaning fluid, and a line that connects this pump to the line branch described in the preceding. A central space intended to accommodate a scavenging air lance in conjunction with a further scavenging air lance located underneath the rotor system is also associated with the need for a not inconsiderable construction volume.

The filtration device known from the document EP 1 433 511 B1 differs from the one disclosed in DE 10 2004 063 879 A1 only in the method by which the liquid bath is ventilated. A hollow shaft, whose interior cavity is divided into two separate sections, extends within the space that is enclosed by the rotor system. One of the sections of the hollow shaft communicates with a compressed air generator, wherein two line sections having closed frontal faces and extending parallel to the hollow shaft and being furnished with outlet holes are arranged in continuous connection with said section, ensuring a practically complete distribution of rising air bubbles within said space. The other section of the inner space communicates with a vacuum pump, which together with in interposed line network serves to create the representation of a suction effect within the individual filter elements. The rotor system is supported on the hollow shaft so as to be rotatable and is in driven connection with an electric motor.

It is true that the more or less complete distribution of rising air bubbles results in a better ventilation and purification effect than that of the filtration device according to the first document cited. However, this is limited only to the cavity surrounded by the rotor system. Again, the air bubbles are supplied in an area of the rotor system that is close to the axis, a feed of the liquid to be filtered also being furnished in the upper area of the liquid bath outside the rotor system. In this arrangement, it is not possible to achieve optimum distribution of the air bubbles to the fullest extent in the flow field created by the rotation of the rotor system with the objective of preventing deposits from forming on the filter elements, because the ventilation effect does not extend to the full width of the rotor system.

An essential feature of this state of the art consists in that the liquid to be filtered is delivered more or less precisely to a location in the liquid bath outside of the rotor system. Measures that influence the liquid directly and are intended to merge the liquid with the stream of rising air bubbles escaping from the jetting lance or jetting to lance assembly are not evident. It may therefore be assumed that a concentration distribution that is dependent on the type of solid phase load forms inside the liquid bath. This may lead to an increase in the concentration of solids, and consequently deposits in the liquid bath. Deposits increase the energy required for filtering as well as the energy required for feeding the scavenging air, and have a detrimental effect on the filtering efficiency.

A further filtration device is known from EP 1 149 619 A1 in which a rotor system is supported so as to be rotatable about a horizontal axis and is located inside a liquid bath comprising a liquid charged with solid particles, the rotor system comprising a number of filter discs arranged on a hollow shaft with a uniformly shaped space between them. The liquid bath is provided with a delivery system for the liquid arranged on the perimeter in the upper area, whereas the filtrate that is recovered via the filter discs is collected and removed in a collector line equipped with a vacuum pump. A distributor lance intended for guiding liquid that is to be filtered extends into the hollow shaft, and the end of the distributor lance that protrudes from the hollow shaft is connected to a line with a pump arranged in the course thereof, the intake side of the pump being located in the lower part of the liquid bath. Although the use of the distributor lance does help to even out the impact of the liquid on the filter disc assembly, this is still associated with significant construction effort. Furthermore, since the liquid is aspirated at a precise location, it is not possible to prevent the formation of deposits in the lower region of the liquid bath with sufficient reliability.

The object of the invention is to improve a filtration device of the species described in the introduction in such manner that the formation of deposits on the filter elements and in the liquid bath is eliminated as far as possible, without any loss of filter efficiency, thereby also enabling essentially stable and economical operation. This object is solved in such a filtration device with the features described in the characterizing part of claim 1.

It is essential to the invention that the introduction of the liquid into the liquid bath to be filtered takes place in an area that is close to the axis of the rotor system and thus also central. The rotating rotor system exerts an entraining effect in the liquid that induces a flow field aligned with this direction of rotation, with the result that a force effect is created on the particles that are thus introduced into the centre of the liquid bath with the liquid, urging them radially outwards, that is to say towards the assemblies that support the filter discs, in particular towards the spaces that exist between the filter discs. The introduction of the liquid may be regulated with the aid of the distributor lance provided that the entire axial length of the rotor system is placed under uniform load, thereby ensuring that correspondingly uniform use of the entire volume of the liquid bath is enabled. The liquid is thus subjected to a guidance effect that is adapted optimally to the filtration process as it is introduced into the liquid bath.

A device designed for ventilation corresponding to the features of claim 2 is preferably arranged on the bottom inside the liquid bath, that is to say below the rotor system.

The features of claim 3 relate to a pretreatment of the liquid that is to be filtered. Accordingly, it is essential to the invention that the liquid is introduced into the liquid bath by means of a pump with the interposition of a prefilter, so that particles above a definable size, which would otherwise accumulate in the liquid and impair the filtration efficiency are extracted from the liquid. By this method, a coarse fraction with a particle size roughly equal to the width of the space between two filter discs may be separated out of the liquid. Purely for exemplary purposes, this width may be about 8 mm. The prefilter is thus designed to remove particles that are larger than the lateral distances between the filter discs in any case. In this way, the particles are prevented from collecting between the filter discs, and in particular they are prevented from flowing round the outside of the filter discs, so that the liquid charged with particles is able to flow through the spaces between the filter discs and is exposed to the effect of the filters.

In the simplest case, the rotor system includes just one assembly of filter discs positioned side by side that in this case extends coaxially with the axis of the rotor system. If there are two or more assemblies, the axes thereof extend parallel and eccentrically with respect to the rotor system axis. The features of claim 4 relate to the structural configuration of the distributor lance and its arrangement inside the rotor system. Accordingly, the rotor system comprises a hollow shaft via which it is mounted so as to be drivable about a horizontal axis in the liquid bath, wherein the one or more distributor lance(s) is/are attached to this hollow shaft and rotate with it. The distributor lance is provided with outlet openings over its entire length, to ensure that the liquid bath is loaded uniformly.

According to the features of claim 5, one end of the distributor lance is connected to a distribution chamber that extends around the hollow shaft of the rotor system in the manner of an annular cylinder. The distribution chamber, which in turn is charged with liquid to be filtered via an inner chamber section of the hollow shaft, may be used advantageously for attaching additional distributor lances, which are of identical construction and all extend parallel to the axis of the hollow shaft. The inner chamber section referred to communicates via a rotary feedthrough with the line that includes the prefilter.

The features of claim 6 relate to the further refinement of the elements that serve to transport the filtrate to the outside via a line on the outlet side.

The features of claim 7 relate to a further refinement of an assembly. Accordingly, the central cylindrical pipe of such an assembly may serve in the same way as the central hollow shaft of the rotor system as the support for at least one distributor lance, via which liquid for filtration is introduced into the liquid bath. These additional distributor lances preferably extend the entire length of an assembly and are expediently in communication with the distributor chamber described previously.

According to the features of claim 8, a network made up of lines furnished with outlet apertures is provided on the bottom inside the liquid bath, and this network forms an device for introducing air bubbles into the liquid bath. The outlet apertures and the lines of this network are deliberately structured in such manner that a uniformly distributed stream of rising air bubbles is formed in the liquid bath and permeates the entire volume of the rotor system correspondingly evenly. The flow field induced by this stream of air bubbles is superimiposed on the one that is generated by the rotary motion of the rotor system and runs counter to it to a certain degree. This results in an intensive mixing action and works particularly effectively against the formation of solid accumulations and thus also of deposits.

The energy that is consumed via the pump that feeds the liquid to be filtered into the rotor system is used to compensate for the energy consumed for prefiltering. It is also used to introduce the prefiltered liquid into the rotor system via the distributor lances, wherein a stream directed out of the inner region of the rotor system and towards the free surface of the liquid bath is created in conjunction with the stream of rising air bubbles. The pressure exerted via this pump is also adjusted so as to avoid forcing the solids load into the spaces between the filter discs, so that movement of the liquid to be filtered is influenced primarily by the stream of rising air, creating a low-density zone that counteracts the formation of deposits. Based on these conditions, the energy expenditure that is necessary in order to apply the compressed air may be kept lower than in the related art described in the introduction, because the loading of the liquid charged with solids that reaches the liquid bath is low as a result of the prefiltering.

According to the features of claims 9 and 10, the pumps that are intended to feed the liquid to be filtered and to extract the filtrate are designed to be individually switchable between a suction and a pressure mode. This means that the direction of flow within the liquid bath, particularly in the lines that connect these pumps to the liquid bath, is reversible, a condition that is useful for scavenging the filter surfaces, that is to say removing any deposits that form, and for other purposes.

Reversing the flow direction as described in the preceding enables a liquid or gas-phase cleaning agent or other water-soluble chemical to be introduced into the filtrate as it flows back, or the clean water that is fed in may be mixed with it. In this way, all filter surfaces are flushed with the same cleaning solution. After completion of such a flushing operation, a normal mode, that is intended to recover filtrate, may be resumed by reversing the flow direction again.

According to the features of claim 11, the filter discs are constructed in known manner as hollow bodies, the interior cavities of which are in continuous to communication with the line designed to remove the filtrate.

In the following, the invention will be described in greater detail with reference to the exemplary embodiment represented in the drawing. In the drawing:

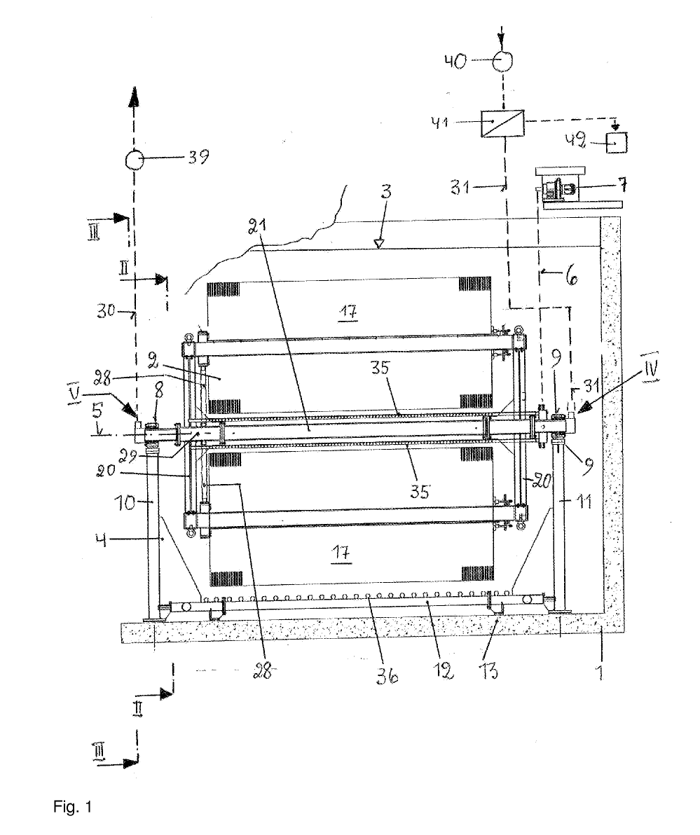

FIG. 1 is a partial view of a filtration device according to the invention in a vertical longitudinal cross-sectional plane;

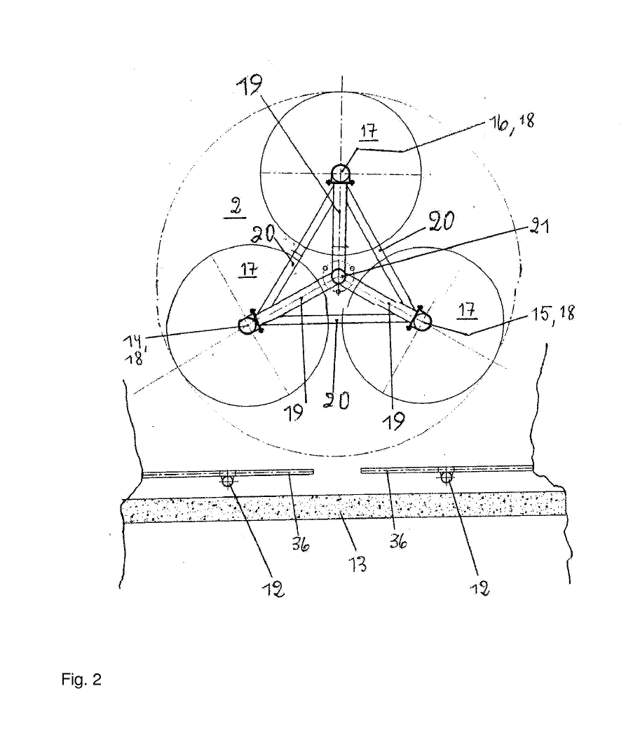

FIG. 2 is a partial view of the filtration device shown in FIG. 1 in a cross-sectional plane II-II;

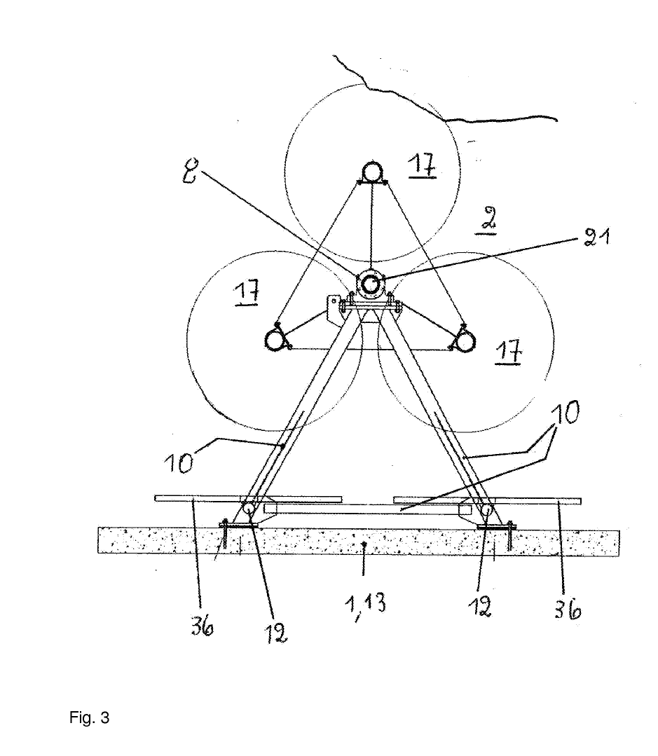

FIG. 3 is a partial view of the filtration device shown in FIG. 1 in a cross-sectional plane III-III;

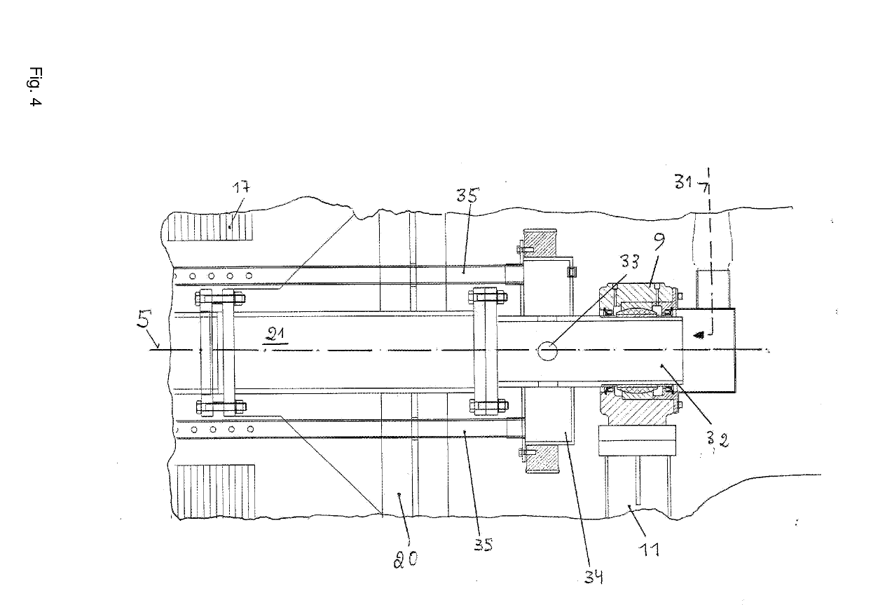

FIG. 4 is an enlarged partial view of an axial section of detail IV in FIG. 1;

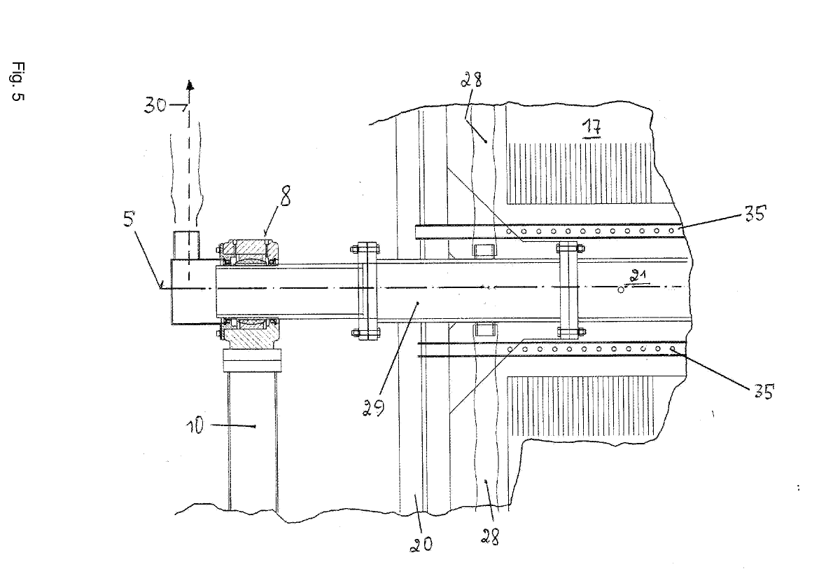

FIG. 5 is an enlarged partial view of an axial section of detail V in FIG. 1;

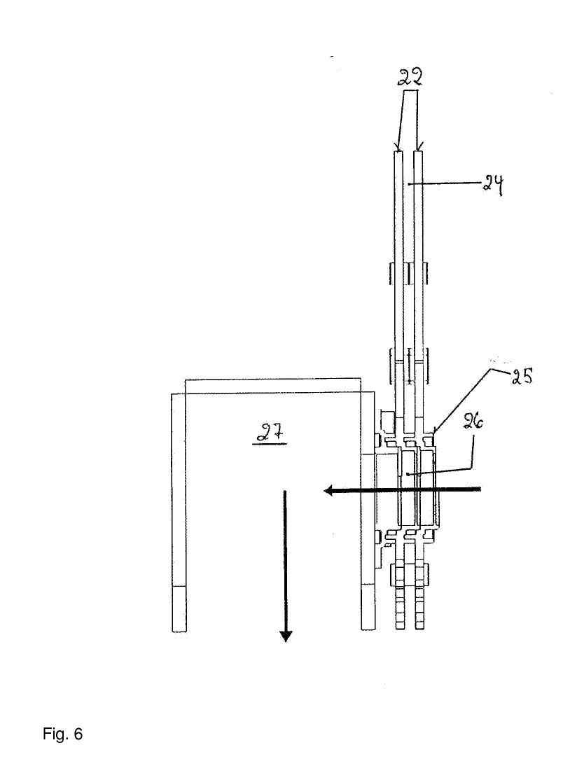

FIG. 6 is a partial view of an axial section of two filter discs forming part of the filtration device;

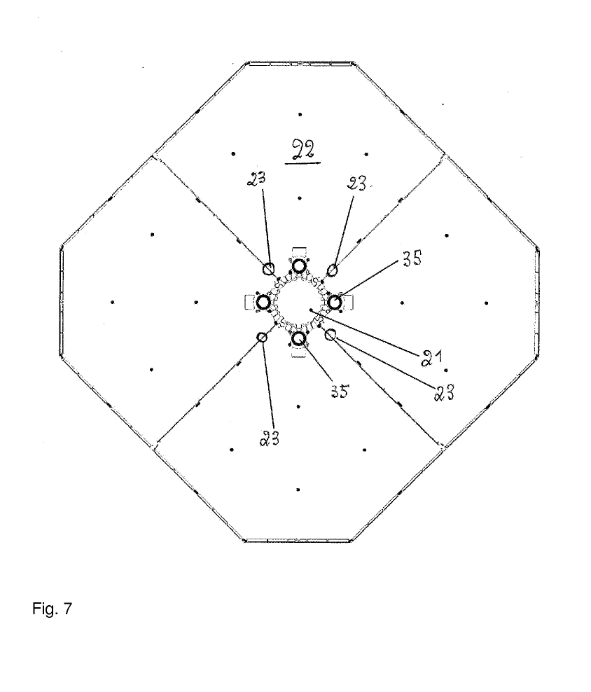

FIG. 7 is a view of the frontal face of a filter disc.

The filtration device shown in FIG. 1 comprises a receptacle 1, that is open at the top and intended to hold liquid that is to be filtered, and a rotor system 2, which will be described in the following, and is installed in fixed manner on the bottom and inside the receptacle. When the device is in operation, rotor system 2 is submerged below the level of the liquid 3 in receptacle 1.

Rotor system 2 is supported so as to be rotatable about a horizontal axis 5 in a rack structure 4 that is installed on the bottom inside receptacle 1 and is in driven connection with an electric motor 7 arranged above receptacle 1 via a traction drive 6, for example a toothed belt drive. Rack structure 4 comprises two essentially identically constructed bearing supports 10, 11 that accommodate bearing units 8, 9 at the frontal ends of rotor system 2, and each of which forms a triangular support structure and are connected to one another via longitudinal struts 12 that extend along the bottom. Bearing supports 10, 11 are fastened to the floor 13 of the receptacle by suitable means and may for example be bolted thereto.

is Bearing units 8, 9 are advantageously configured in such manner that rotor system 2 may easily be removed from receptacle 1 as a unitary subassembly and re-installed in receptacle 1. Maintenance operations on rotor system 2 are thus simplified.

Rotor system 2 comprises for example three assemblies 17 that include individual filter discs 22 and each of which is retained on axes 14, 15, 16 that are parallel with each other and with axis 5. Each of these assemblies 17 comprises a central annular cylinder 18 that extends coaxially with the respective axis 14, 15, 16, wherein the ends of these annular cylinders 18 are braced via a star-shaped assembly extending in a plane perpendicular to axes 14, 15, 16 by annular cylinders 20 that form a bearing frame structure on a central hollow shaft 21 that is supported so as to be rotatable about axis 5 and supports rotor system 2, and at the same time function as collecting lines for the recovered filtrate. Joint braces 19 that are arranged in triangular manner at the ends of rotor system 2 assist with stabilisation.

Assemblies 17 are preferably retained inside rotor system 2 so that they may be disassembled or installed easily as a subassembly if necessary.

Filter discs 22 are arranged in a closely staggered arrangement and with relatively small spaces 24 therebetween on the annular tube 18 that forms a bearing structure, and are connected to each other via coupling elements 25 that are arranged in an area close to the axis, are insertable into one another in sealing manner, and form a line segment when combined, in such manner that the totality of these coupling elements 25 forms a filtrate collection line 26.

Each of the filter discs 22 forms a hollow structure, the filter surfaces of which are covered with a membrane or some other filter fabric, which is suitable for filtering a particle size of greater than 0.2 μm to 1.0 μm for example. The inner space of this hollow structure is in communication with filtrate collection line 26.

The totality of all filtrate collection lines 26 of any assembly 17 is in continuous connection with a filtrate receiving chamber 27, wherein all of these filtrate receiving chambers 27 in their turn are combined via connecting elements 28 and annular cylinders 20 into a collection chamber 29 formed by a section of hollow shaft 21. The filtrate may be transported away from this collection chamber 29 via line 30, in the course of which a pump 39 is arranged, wherein the pump is configured as a suction pump and provides the pressure differential in the area of filter discs 22 that is necessary in order for filtration to take place.

The liquid for filtration that is charged with contaminants passes via a line 31 initially into an inlet chamber 32 that is in permanent communication with hollow shaft 21, and from this via peripheral apertures 33 into a distributor chamber 34 that encloses the former in the manner of a ring, and the external side of which forms a part of traction drive 6.

A pump 40 is used to transport the liquid to be filtered into inlet chamber 32, and is used with the interposition of a prefilter 41 in line 31. Pump 40 is designed in the normal manner for pressure mode and is intended to provide the pressure differential necessary for filtration in prefilter 41. Prefilter 41 serves to remove coarser contaminants at this point, for example in the form of sand, plastic and wood particles, so that they cannot compromise the filtration process in the liquid bath by forming deposits. The coarse fraction that is separated in prefilter 41 is collected in a catch tank 42 and forwarded for further use. The pressure provided via pump 40 is applied in such manner that said coarse fraction is able to be transported to catch tank 42 without any additional measures.

Pump 40 and prefilter 41 together form a part a the filtration device according to the invention, by means of which the burden of solids in the liquid bath and thus also the formation of deposits may be limited, thereby helping in this respect to promote stable operation over time and to improve the average filtration efficiency.

A series of distributor lances 35 provided outside hollow shaft 21 are attached to the to outside of distributor chamber 34, and are preferably arranged evenly about the circumference thereof and extending parallel to axis 5 and for the entire axial length of rotor system 2. These distributor lances 35 are furnished with holes around the circumference thereof, which are intended to allow the liquid to be filtered to pass out of distributor lances 35 and into receptacle 1.

As may be seen in FIG. 7, additional distributor lances 23 may be assigned to any of assemblies 17. These are passed through cutouts in filter discs 22 and retained inside these, parallel to and close to the axis of the supporting annular tube 21 in each case. They are continuously connected to inlet chamber 32 in a way that isn't shown in the drawing. These additional distributor lances 23 are furnished with outlet apertures that open into the liquid bath in the same way as distributor lances 35.

The escape of liquid from these additional distributor lances 23 may be configured so as to be controllable via interposed shut-off devices, thereby enabling further control of the flow field within the liquid bath.

The pressure to be provided by pump 40 is selected in accordance with the required pressure drop in prefilter 41 and so as to ensure that the contaminants that are transported with the liquid and exit from distributor lances 35 are not forced into the spaces 24 between the filter discs, but first form a steady flow zone that surrounds hollow shaft 21, in which they are exposed to the effect of the stream of rising air bubbles.

Reference number 36 designates a network of pipelines arranged inside and on the bottom of the receptackle, below rotor system 2, which may be supported for example on longitudinal struts 12 and serves to introduce compressed air into the liquid bath in receptacle 1 through evenly spaced holes. Network 36 and said holes are arranged in such manner that an area is created within spaces 24 between filter discs 22 in which evenly distributed air bubbles rise and create an upwardly directed flow field, exercising a cleaning effect on the filter surfaces of filter discs 22 that is designed to remove deposits.

to In practical terms, the pipelines of network 36 may be constructed from perforated support tubes, each of which is covered with a perforated, tubular membrane made for example from an elastomer material that is placed over the tube. When compressed air is introduced, the membrane expands under the additional pressure, thus permitting the escape of air bubbles into the liquid bath.

In general, the flow induced in the liquid bath by the introduction of compressed air may also be used to drive rotor system 2. However, this requires that the flow be concentrated within a given area and the adoption of certain design engineering measures on the rotor system in order to harness the flow energy that is to be transmitted for this purpose.

During operation, contaminated water, for example wastewater charged with a burden of solid materials, is fed to the filtration device with the aid of pump 40 along line 31 and through prefilter 41.

The prefiltered contaminated water reaches the liquid bath in receptacle 1 via distribution chamber 34, inlet chamber 32 and distributor lances 35. In receptacle 1, rotor system 2 rotates about axis 5, and an upwardly directed flow caused by the air bubbles rising from network 36 is superimposed on the bath motion induced by this rotary movement.

A condition of reduced pressure is created in the area of collection chamber 29 by pump 39 and acts on the inner side of each filter disc 22 via annular tubes 20, connecting elements 28, collection chamber 27 and filtrate collection line 26 to create a pressure differential on either side of the membrane or of a filter fabric located at this point, thereby producing a filter effect. The recovered filtrate from all assemblies 17 is transported away towards collection chamber 27, and at the same time a powerful cleaning effect is exerted on filter discs 22 that also prevents the accumulation of deposits due to the superimposed effect of the rotating rotor system 2 and of the flow induced by the rising air bubbles. Solid materials that are introduced are thus kept in a suspended state.

During regular operation of the filtration device, a liquid to be filtered is fed to inlet chamber 32 under pressure, wherein the rotation of rotor system 2 and the rising air bubbles that pass through it steadily have the effect of at least retarding deposit formation. This effect may be enhanced particularly advantageously if pump 40, which is arranged at the inlet side to transport the liquid for filtration, is switched from a pressure to a suction mode, and at the same time pump 39, which serves to is transport the filtrate, is switched from a suction to a pressure mode. This means that now contaminated water is drawn out of the liquid bath and through distributor lances 35. Rotor system 2 continues to rotate during this operation, and the stream of air bubbles rising in the liquid bath is also not interrupted.

The system of distributor lances 23, 35 may also be used to introduce such a chemical reagent together with the liquid to be filtered into the liquid bath, particularly into the spaces between filter discs 22, the effect of which serves to suppress bacterial growth in the area of the filter surfaces, or also for cleaning purposes in this area. These reagents may be used in a solid, liquid or gas-phase form that is soluble in the liquid.

Particularly when a switch between inlet-side pressure and suction phases has been programmed by corresponding actuation of pumps 39, 40, an optimal cleaning effect is achieved that also suppresses the formation of disruptive deposits, encrustations and suchlike.

The inventive steps, that is to say prefiltering, uniform loading of the rotating rotor system with rising air bubbles originating from the floor area of the liquid bath in conjunction with the introduction of prefiltered liquid through distributor lances 35 are all implemented with the purpose of limiting the solid material burden in the liquid bath and to establish steady flow conditions within the liquid bath that keep solids that do reach the liquid bath in a suspended state and thus effectively counteract the formation of deposits.

### LEGEND

1. Receptacle
2. Rotor system
3. Liquid level
4. Rack structure
5. Axis
6. Traction drive
7. Electric motor
8. Bearing unit
9. Bearing unit
10. Bearing support
11. Bearing support
12. Longitudinal struts
13. Bottom
14. Axis
15. Axis
16. Axis
17. Assembly
18. Annular tube
19. Annular tube
20. Joint braces
21. Hollow shaft
22. Filter disc
23. Distributor lance
24. Space
25. Coupling element
26. Filtrate collector line
27. Filtrate receiving chamber
28. Connecting element
29. Collection chamber
30. Line
31. Line
32. Inlet chamber
33. Aperture
34. Distribution chamber
35. Distributor lance
36. Network
37.
38.
39. Pump
40. Pump
41. Prefilter
42. Catch tank

1. A filtration device for recovering filtrate from a liquid charged with insoluble solid materials, comprising a rotor system (2) that is drivable in rotary manner about a horizontal axis (5) in a bath formed by the liquid in a receptacle (1), and which supports at least one assembly (17) of filter discs (22) arranged side-by-side, a line (31) for the purpose of feeding the liquid to be filtered and a line (30) for the purpose of transporting the filtrate away, wherein the rotor system (2) has a central hollow shaft (21) serving as a bearing therefor, wherein the interior spaces of the filter discs (22) are in permanent communication with the line (30) for the purpose of transporting the filtrate away, and wherein a device constituted by a network (36) of lines furnished with outlet apertures for introducing air bubbles is arranged in the liquid bath and is located underneath the rotor system (2), enabling the air bubbles to escape and rise according to a pattern that encompasses the entire area of the rotor system (2) evenly, characterized in that at least one distributor lance (35) for the purpose of introducing the liquid to be filtered into the liquid bath is provided inside the rotor system (2), adjacent to the axis (5) thereof and extending parallel thereto, and that the or each distributor lance (35) is arranged so as to rotate together with the hollow shaft (21).

2. The filtration device according to claim 1, characterized in that a pump (40) is arranged in the line (31) for the purpose transporting the liquid to the liquid bath with the interposition of a prefilter (41) that is configured to separate out particles larger than a definable size.

3. The filtration device according to claim 1, characterized in that the at least one distributor lance (35) extends essentially for the entire axial length of the rotor system (2) and comprises a hollow body that is furnished with outlet apertures, preferably arranged evenly over its entire length.

4. The filtration device according to claim 1, characterized in that the or each distributor lance (35) is connected to a distribution chamber (34) that is permanently connected to the hollow shaft (21) and surrounds the shaft in the manner of an annular tube, the distribution chamber itself being connected to the line (31) via an inlet chamber (32) that is formed by a section of the hollow shaft (21).

5. The filtration device according to claim 1, characterized in that each of the assemblies (17) is connected via a filtrate receiving chamber (27) to a collection chamber (29) that combines the filtrate from all assemblies (17) and is connected to line (30).

6. The filtration device according to claim 1, characterized in that at least one additional distribution lance (23) is provided parallel to the axis of an assembly (17) and permanently connected thereto for the purpose of introducing liquid to be filtered into the liquid bath, and is connected to line (31).

7. The filtration device according to claim 2, characterized in that the pump (40) is configured so as to be switchable between a pressure and a suction mode.

8. The filtration device according to claim 1, characterized in that a pump (39) deployed in the line (30) in order to draw off filtrate by suction is designed to be switchable between a pressure and a suction mode.

9. The filtration device according to claim 2, characterized in that the at least one distributor lance (35) extends essentially for the entire axial length of the rotor system (2) and comprises a hollow body that is furnished with outlet apertures, preferably arranged evenly over its entire length.

10. The filtration device according to claim 2, characterized in that the or each distributor lance (35) is connected to a distribution chamber (34) that is permanently connected to the hollow shaft (21) and surrounds the shaft in the manner of an annular tube, the distribution chamber itself being connected to the line (31) via an inlet chamber (32) that is formed by a section of the hollow shaft (21).

11. The filtration device according to claim 3, characterized in that the or each distributor lance (35) is connected to a distribution chamber (34) that is permanently connected to the hollow shaft (21) and surrounds the shaft in the manner of an annular tube, the distribution chamber itself being connected to the line (31) via an inlet chamber (32) that is formed by a section of the hollow shaft (21).

12. The filtration device according to claim 2, characterized in that each of the assemblies (17) is connected via a filtrate receiving chamber (27) to a collection chamber (29) that combines the filtrate from all assemblies (17) and is connected to line (30).

13. The filtration device according to claim 3, characterized in that each of the assemblies (17) is connected via a filtrate receiving chamber (27) to a collection chamber (29) that combines the filtrate from all assemblies (17) and is connected to line (30).

14. The filtration device according to claim 4, characterized in that each of the assemblies (17) is connected via a filtrate receiving chamber (27) to a collection chamber (29) that combines the filtrate from all assemblies (17) and is connected to line (30).

15. The filtration device according to claim 2, characterized in that at least one additional distribution lance (23) is provided parallel to the axis of an assembly (17) and permanently connected thereto for the purpose of introducing liquid to be filtered into the liquid bath, and is connected to line (31).

16. The filtration device according to claim 3, characterized in that at least one additional distribution lance (23) is provided parallel to the axis of an assembly (17) and permanently connected thereto for the purpose of introducing liquid to be filtered into the liquid bath, and is connected to line (31).

17. The filtration device according to claim 3, characterized in that the pump (40) is configured so as to be switchable between a pressure and a suction mode.

18. The filtration device according to claim 4, characterized in that the pump (40) is configured so as to be switchable between a pressure and a suction mode.

19. The filtration device according to claim 2, characterized in that a pump (39) deployed in the line (30) in order to draw off filtrate by suction is designed to be switchable between a pressure and a suction mode.

20. The filtration device according to claim 3, characterized in that a pump (39) deployed in the line (30) in order to draw off filtrate by suction is designed to be switchable between a pressure and a suction mode.
